(19) United States
(12) Patent Application Publication
(10) Pub. No.: US 2020/0369559 A1
(43) Pub. Date: Nov. 26, 2020

(54) GLASS COMPOSITION

(71) Applicant: Nippon Sheet Glass Company, Limited, Tokyo (JP)

(72) Inventors: Kazuya OHKAWA, Kanagawa (JP); Teruhide INOUE, Kanagawa (JP); Shingo FUJIMOTO, Tokyo (JP); Taro MIYAUCHI, Kanagawa (JP)

(21) Appl. No.: 16/758,739

(22) PCT Filed: Sep. 27, 2018
(86) PCT No.: PCT/JP2018/036082

§ 371 Date: Apr. 23, 2020

(30) Foreign Application Priority Data
Oct. 25, 2017 (JP) 2017-205806

(51) Int. Cl. C03C 3/093; C03C 3/091

(52) U.S. Cl. CPC C03C 3/093; C03C 3/091

(57) ABSTRACT

The glass composition according to the present invention is a glass composition including SiO₂, B₂O₃, Al₂O₃, an alkaline-earth metal oxide and another metal oxide. When an average thermal expansion coefficient of the glass composition in a temperature range of 0° C. to T° C. is expressed as CTE (T), a relationship of (17.1×10⁻³×T+25.4)×10⁻⁷/° C.≤CTE (T)≤(17.1×10⁻³×T+31.4)×10⁻⁷/° C. is satisfied in a temperature range of 0° C. to 100° C.

### TECHNICAL FIELD

The present invention relates to a glass composition.

### BACKGROUND ART

Conventionally, an integrated circuit is mounted on a board in the form of so-called IC package, which is a package enclosing the integrated circuit. On the other hand, a method called bare chip mounting is gaining popularity in recent years as a method for mounting an integrated circuit (a silicon chip) on a board. Bare chip mounting is a method in which an integrated circuit is mounted on a board in the state of a chip without being enclosed in a package. The popularity of small electronic devices such as a smart phone has led to demands for faster signal processing and lower power consumption. The bare chip mounting has started to be used as one of the techniques to meet such demands. As methods for connecting electrodes in the bare chip mounting, there can be mentioned a wire-bonding method and a flip chip method using a solder ball or a copper pillar.

In bare chip mounting, an integrated circuit is placed on a board. The integrated circuit is made by forming an electronic circuit on a silicon chip having a relatively low thermal expansion coefficient. Therefore, in the case where the board has a relatively high thermal expansion coefficient, warpage and/or strain resulting from the difference between the respective thermal expansion coefficients of the silicon chip and the board placed one on the other may occur due to variations in a working temperature in the process of manufacturing a circuit board and/or an environmental temperature at the time of actually using an electronic device. In addition, a connection, such as a solder ball, between electrodes is broken due to thermal stress developed therein, which may cause problems such that the reliability of electronic parts is lowered and electrical characteristics are deteriorated. In light of this, a glass having a thermal expansion coefficient approximate to that of silicon attracts attention as a material of the board used for the bare chip mounting of the integrated circuit.

In addition, a wiring board called a glass interposer has been developed for practical use. The glass interposer is a glass board having micro through holes made by processing such as laser processing, electric discharge processing and etching. An electrode on a front surface of the glass board and an electrode on a back surface of the glass board are connected electrically to each other via the micro through hole. A glass material for such a wiring board has a low thermal expansion coefficient, which is, for example, a thermal expansion coefficient equal to or approximate to a thermal expansion coefficient of silicon in a specific temperature range. This reduces, to some extent, the occurrence of disconnection and stress strain resulting from thermal expansion. Patent Literatures 1 to 7 each describe such a glass and a thermal expansion coefficient of the glass.

Such a glass is not only used as a wiring board suitable for bare chip mounting but also used suitably as a no-wiring support board and a cap glass to be bonded to a bare chip from the view point of reducing warpage and improving reliability of the bonded portion.

### CITATION LIST

### Patent Literature

### Patent Literature 1: JP 2008-156200 A

### Patent Literature 2: JP 2014-118313 A

### Patent Literature 3: JP 2016-117641 A

### Patent Literature 4: JP 2016-155692 A

### Patent Literature 5: JP 2016-188148 A

### Patent Literature 6: JP 2017-7940 A

### Patent Literature 7: JP 2017-114685 A

### SUMMARY OF INVENTION

### Technical Problem

According to prior art, there is still room for allowing a glass to have a thermal expansion coefficient more approximate to the thermal expansion coefficient of a semiconductor such as silicon in a wide temperature range. Therefore, the present invention provides a glass composition having a thermal expansion coefficient more approximate to the thermal expansion coefficient of a semiconductor, such as silicon, in a wide temperature range.

### Solution to Problem

The present invention provides a glass composition including SiO₂, B₂O₃, Al₂O₃, an alkaline-earth metal oxide and another metal oxide, wherein

when an average thermal expansion coefficient of the glass composition in a temperature range of 50° C. to T° C. is expressed as CTE (T),

a relationship of (17.1×10⁻³× T+25.4)×10⁻⁷/° C.≤CTE (T)≤(17.1×10⁻³× T+31.4)×10⁻⁷1° C. is satisfied in a temperature range of 0° C. to 100° C.

### Advantageous Effects of Invention

The glass composition described above has a thermal expansion coefficient more approximate to the thermal expansion coefficient of a semiconductor, such as silicon, in a wide temperature range.

### BRIEF DESCRIPTION OF DRAWINGS

FIG. 1 is a view schematically illustrating a warpage amount δ of a specimen fabricated by bonding a glass piece and a silicon piece to each other.

FIG. 2 is a graph showing a relationship between temperature and an average thermal expansion coefficient of a glass composition according to each of Examples 1 to 3.

FIG. 3 is a graph showing a relationship between temperature and an average thermal expansion coefficient of a glass composition according to each of Examples 4 to 7.

FIG. 4 is a graph showing a relationship between temperature and an average thermal expansion coefficient of a glass composition according to each of Examples 8 to 12.

FIG. 5 is a relationship between temperature and an average thermal expansion coefficient of a glass composition according to each of Examples 13 to 15.

FIG. 6 is a graph showing a relationship between temperature and an average thermal expansion coefficient of a glass composition according to each of Examples 16 to 18.

FIG. 7 is a graph showing a relationship between temperature and an average thermal expansion coefficient of a glass composition according to each of Examples 19 to 22.

FIG. 8 is a graph showing a relationship between temperature and a warpage amount δ of the glass composition according to each of Examples 1 to 3.

FIG. 9 is a graph showing a relationship between temperature and a warpage amount δ of the glass composition according to each of Examples 4 to 7.

FIG. 10 is a graph showing a relationship between temperature and a warpage amount δ of the glass composition according to each of Examples 8 to 12.

FIG. 11 is a graph showing a relationship between temperature and a warpage amount δ of the glass composition according to each of Examples 13 to 15.

FIG. 12 is a graph showing a relationship between temperature and a warpage amount δ of the glass composition according to each of Examples 16 to 18.

FIG. 13 is a graph showing a relationship between temperature and a warpage amount δ of the glass composition according to each of Examples 19 to 22.

### DESCRIPTION OF EMBODIMENTS

Hereinafter, embodiments of the present invention will be described. The following description shows examples and the present invention is not limited to the following embodiments.

A glass composition of the present invention includes SiO₂, B₂O₃, Al₂O₃, an alkaline-earth metal oxide and another metal oxide. An average thermal expansion coefficient of the glass composition in a temperature range of 50° C. to T° C. is expressed as CTE (T). The glass composition according to the present invention satisfies a relationship of (17.1×10⁻³×T+25.4)×10⁻⁷/° C.≤CTE (T)≤(17.1×10⁻³× T+31.4)×10⁻⁷/° C. is satisfied in a temperature range of 0° C. to 100° C. Single crystal silicon with orientation (100) has an average thermal expansion coefficient that can be approximated as (17.1×10⁻³×T+28.4)×10⁻⁷/° C. in a temperature range of 0° C. to T° C. Therefore, the fact that the glass composition according to the present invention satisfies the above-mentioned relationship allows the difference between the average thermal expansion coefficient CTE (T) of the glass composition and the average thermal expansion coefficient of single crystal silicon with orientation (100) to fall in a range of ±3×10⁻⁷/° C. in a temperature range of 0° C. to 100° C. That is, the average thermal expansion coefficient of the glass composition according to the present invention is approximate to the average thermal expansion coefficient of single crystal silicon in a wide temperature range. Thereby, a circuit board fabricated by placing a silicon chip on a board made of this glass composition has stable properties at the time of actually using an electronic device, for example. Moreover, this allows electronic parts to have high reliability even when the wiring in semiconductor devices becomes finer, which is expected happen in the future, and helps to achieve a mounting board provided with both high-speed signal processing and low power consumption.

The CTE (T) is determined by the following equation (1) when the length of a specimen in a specific direction at a temperature of 50° C. and that at a temperature of T° C. are expressed as L (50) and L (T), respectively. CTE (50) can be determined by arithmetically averaging CTE (25), which is an average thermal expansion coefficient in a range of 50° C. to 25° C. (25° C. to 50° C.), and CTE (75), which is an average thermal expansion coefficient in a range of 50° C. to 75° C. In the present description, the thermal expansion coefficient at a temperature of T° C. means the CTE (T) that is determined by the equation (1), unless otherwise described.

CTE(T)=(L(T)−L(50))/{(T−50)·L(50)} (1)

Desirably, the glass composition of the present invention satisfies a relationship of (17.1×10⁻³×T+25.4)×10⁻⁷1° C.≤CTE (T)≤(17.1×10⁻³×T+31.4)×10⁻⁷ in a temperature range of 0° C. to 250° C. This makes it possible to inhibit warpage from occurring when a board made of this glass composition is bonded to an integrated circuit in the process of mounting the integrated circuit on the board.

More desirably, the glass composition of the present invention satisfies a relationship of (17.1×10⁻³× T+25.4)×10⁻⁷/° C.≤CTE (T)≤(17.1×10⁻³×T+31.4)×10⁻⁷1° C. in a temperature range of −70° C. to 300° C. This makes it possible to increase long-term reliability of a circuit board produced by mounting an integrated circuit on a board made of this glass composition.

Desirably, the glass composition of the present invention satisfies a relationship of (17.1×10⁻³×T+27.4)×10⁻⁷/° C.≤CTE (T)≤(17.1×10⁻³×T+29.4)×10⁻⁷/° C. in a temperature range of 0° C. to 100° C. In this case, the difference between the average thermal expansion coefficient CTE (T) of the glass composition and the average thermal expansion coefficient of single crystal silicon falls in a range of ±1×10⁻⁷/° C. in a temperature range of 0° C. to 100° C. Thus, a board made of this glass composition is advantageous in mounting thereon an integrated circuit having a higher integration density.

More desirably, the glass composition of the present invention satisfies a relationship of (17.1×10⁻³×T+27.4)×10⁻⁷/° C.≤CTE (T)≤(17.1×10⁻³×T+29.4)×10⁻⁷/° C. in a temperature range of 0° C. to 250° C. This makes it possible to inhibit more reliably the warpage from occurring when a board made of this glass composition is bonded to an integrated circuit in the process of mounting the integrated circuit on the board. A board made of this glass composition is advantageous in mounting thereon an integrated circuit having a higher integration density.

Even more desirably, the glass composition of the present invention satisfies a relationship of (17.1×10⁻³×T+27.4)×10⁻⁷/° C.≤CTE (T)≤(17.1×10⁻³×T+29.4)×10⁻⁷/° C. in a temperature range of −70° C. to 300° C. This makes it possible to further increase the long-term reliability of a circuit board produced by mounting an integrated circuit on a board made of this glass composition. Also, a board made of this glass composition is advantageous in mounting thereon an integrated circuit having a higher integration density.

In the glass composition of the present invention, a warpage amount δ determined by the following equation (2) satisfies a relationship of −5 μm≤δ≤5 μm in a temperature range of 0° C. to 100° C., for example. In the equation (2), L₀ is 10 mm, T denotes a temperature [° C.], CTE_{G} (T) is an average thermal expansion coefficient [1° C.] of the glass composition at a temperature of T° C., CTE_{S} (T) is an average thermal expansion coefficient [1° C.] of single crystal silicon at a temperature of T° C., h is 0.4 mm, E₁ is a Young's modulus of the glass composition, and E₂ is a Young's modulus of single crystal silicon with orientation (100).

δ={L₀²(CTE_{G}(T)−CTE_{S}(T))T/h}·[δE₁E₂/{(E₁+E₂)²+12E₁E₂}] (2)

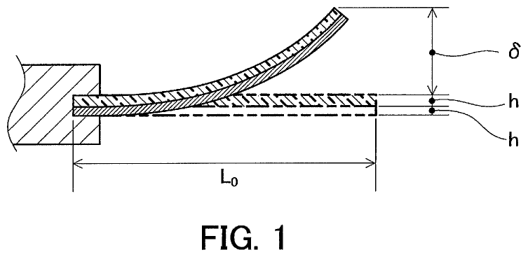

As shown in FIG. 1, the warpage amount δ corresponds to a warpage amount of a specimen S caused by thermal expansion at a temperature of T° C. when the specimen is fixed to be cantilevered. The specimen S is fabricated by bonding a plate-like glass piece A made of the glass composition to a plate-like silicon piece B made of single crystal silicon. The glass piece A and the silicon piece B each have a thickness of 0.4 mm, and also have a length of 10 mm at a temperature of 0° C. When the temperature T=0° C., the warpage amount δ=0. The glass piece A and the silicon piece B can be bonded to each other by a known bonding method such as bonding using a die bonding material and flip chip bonding using a solder bump and a copper pillar.

When the warpage amount δ satisfies the above-mentioned relationship, warpage is unlikely to occur in the case where a circuit board is produced by placing a silicon chip on a board made of the glass composition according to the present invention.

In the glass composition of the present invention, the warpage amount δ desirably satisfies a relationship of −5 μm≤δ≤10 μm in a temperature range of 0° C. to 250° C. More desirably, the warpage amount δ satisfies a relationship of −5 μm≤δ≤10 μm in a temperature range of −70° C. to 300° C. in the glass composition of the present invention. Even more desirably, the warpage amount δ satisfies a relationship of −5 μm≤δ≤20 μm in a temperature range of −70° C. to 400° C. in the glass composition of the present invention.

The glass composition of the present invention has, for example, the following composition in mol %:

45.0 to 68.0% of SiO₂;

1.0 to 20.0% of B₂O₃;

3.0 to 20.0% of Al₂O₃;

0.1 to 10.0% of TiO₂;

0 to 9.0% of ZnO;

2.0 to 15.0% of MgO;

0 to 15.0% of CaO;

0 to 15.0% of SrO;

0 to 15.0% of BaO;

0 to 1.0% of Fe₂O₃; and

0 to 3.0% of CeO₂.

Each component that may be contained in the above-mentioned glass composition will be described.

(1) SiO₂

SiO₂ is a network-forming oxide constituting a main glass network. Incorporation of SiO₂ in the glass composition contributes to an increase in chemical durability of the glass composition and also allows for adjustment of the temperature-viscosity relationship in the glass composition and adjustment of the devitrification temperature of the glass composition. When the SiO₂ content in the glass composition is equal to or less than a predetermined value, it is possible to melt the glass composition at a temperature lower than 1700° C. which is practical. In contrast, when the SiO₂ content in the glass composition is equal to or greater than a predetermined value, it is possible to prevent a liquidus temperature at which devitrification occurs from being lowered. The SiO₂ content in the glass composition of the present invention is desirably 45.0 mol % or more, more desirably 50.0 mol % or more. The SiO₂ content in the glass composition of the present invention is desirably 68.0 mol % or less, more desirably 66.0 mol % or less, even more desirably 65.0 mol % or less, and particularly desirably 63.0 mol % or less.

(2) B₂O₃

B₂O₃ is a network-forming oxide constituting a main glass network, similarly to SiO₂. Incorporation of B₂O₃ in the glass composition allows a glass to have a lowered liquidus temperature and hence allows the glass composition to have a practical melting temperature. In an alkali-free or low-alkali glass having a relatively high SiO₂ content, it is desirable that the B₂O₃ content be equal to or greater than a predetermined value so that the glass composition can be melted at a temperature lower than 1700° C. which is practical. In the case where the B₂O₃ content is equal to or less than a predetermined value, the amount of a component evaporated while the glass composition is melted at a high temperature is reduced and the compositional ratio of the glass composition is maintained stably. The B₂O₃ content is desirably 1.0 mol % or more, and more desirably 2.0 mol % or more. The B₂O₃ content in the glass composition of the present invention is desirably 20.0 mol % or less, more desirably 15.0 mol % or less, and even more desirably 12.0 mol % or less.

(3) Al₂O₃

Al₂O₃ is a so-called intermediate oxide that may function as a network-forming oxide or as a modifying oxide depending on the balance between the content of the above network-forming oxides, which are SiO₂ and B₂O₃, and the content of the alkaline-earth metal oxides described below as modifying oxides. Al₂O₃ is in a tetracoordinated state and acts as a component that stabilizes a glass, prevents phase separation of a borosilicate glass, and enhances chemical durability of the glass composition. In an alkali-free or low-alkali glass having a relatively high SiO₂ content, it is desirable that the Al₂O₃ content be equal to or greater than a predetermined value so that the glass composition can be melted at a temperature lower than 1700° C. which is practical. On the other hand, it is desirable that the Al₂O₃ content be equal to or less than a predetermined value in order to inhibit the melting temperature of a glass from rising and to form the glass stably. The Al₂O₃ content is desirably 3.0 to 20.0 mol %. An Al₂O₃ content of 6.0 mol % or more can inhibit a strain point of the glass composition from being lowered. An Al₂O₃ content of 17.0 mol % or less can easily prevent a surface of a glass from being cloudy. Therefore, the Al₂O₃ content is more desirably 6.0 mol % or more, even more desirably 6.5 mol % or more, particularly desirably 7.0 mol % or more, and most desirably 7.5 mol % or more. The Al₂O₃ content is more desirably 19.0 mol % or less, and even more desirably 18.0 mol % or less.

(4) TiO₂

TiO₂ is an intermediate oxide. It is known that, in glass processing by laser ablation, incorporation of TiO₂ in a glass to be processed can lower the laser processing threshold (see JP 4495675 B2). Also, in a method for manufacturing a perforated glass by a combination of laser irradiation and etching, incorporation of an appropriate amount of TiO₂ in an alkali-free or low-alkali glass having a specific composition allows formation of modified portions by irradiation with a relatively low-energy laser. Moreover, the modified portions can be removed easily by the subsequent etching. Moreover, coloring of the glass composition can be controlled by making use of interaction between TiO₂ and another colorant. Thus, it is possible to manufacture a glass that can properly absorb certain light by adjusting the TiO₂ content in the glass composition. In this manner, the glass has an appropriate absorption coefficient, so that it is easy to form modified portions that are to be removed and turned into holes in the etching step. Therefore, the glass composition desirably contains an appropriate amount of TiO₂. In the glass composition according to the present invention, the TiO₂ content is desirably 0.1 mol % or more, more desirably 1.0 mol % or more, and even more desirably 3.0 mol % or more based on the assumption of the combined use of TiO₂ and another coloring component that is selected from oxides of metals such as Ce, Fe and Cu. Also, the TiO₂ content in the glass composition of the present invention is desirably 10.0 mol % or less, and more desirably 7.0 mol % or less.

(5) ZnO

ZnO can act as an intermediate oxide, similarly to TiO₂. ZnO also shows absorption in the ultraviolet region, similarly to TiO₂. Thus, ZnO exhibits beneficial effects when incorporated in the composition. However, the glass composition according to the present invention may be substantially free of ZnO. In the glass composition according to the present invention, the ZnO content is desirably 0 mol % or more, more desirably 1.0 mol % or more, even more desirably 3.0 mol % or more based on the assumption of the combined use of ZnO and another coloring component that is selected from oxides of metals such as Ce, Fe and Cu. Also, the ZnO content in the glass composition of the present invention is desirably 9.0 mol % or less, more desirably 8.0 mol % or less, and even more desirably 7.0 mol % or less.

(6) MgO

MgO is an alkaline-earth metal oxide and characterized in that it suppresses an increase in the thermal expansion coefficient of the glass composition without causing a significant decrease in the strain point of the glass composition. MgO also improves the meltability of the glass composition. Thus, the glass composition according to the present invention desirably contains MgO. An MgO content, in the glass composition, equal to or less than a predetermined value can suppress phase separation of a glass, and can suppress a decrease in devitrification resistance and a decrease in acid resistance of the glass. The MgO content in the glass composition of the present invention is desirably 2.0 mol % or more, more desirably 3.0 mol % or more, and even more desirably 4.0 mol % or more. Also, the MgO content in the glass composition of the present invention is desirably 15.0 mol % or less, and more desirably 12.0 mol % or less.

(7) CaO

Similarly to MgO, CaO is characterized in that it suppresses an increase in the thermal expansion coefficient of the glass composition without causing a significant decrease in the strain point of the glass composition. CaO also improves the meltability of the glass composition. Thus, the glass composition according to the present invention may contain CaO. A CaO content, in the glass composition, equal to or less than a predetermined value can suppress a decrease in the devitrification resistance, an increase in the thermal expansion coefficient, and a decrease in the acid resistance. The CaO content in the glass composition according to the present invention is desirably 1.0 mol % or more, and more desirably 2.0 mol % or more. Also, the CaO content in the glass composition according to the present invention is desirably 15.0 mol % or less, more desirably 12.0 mol % or less, even more desirably 10.0 mol % or less, and particularly desirably 9.0 mol % or less. The glass composition according to the present invention may be substantially free of CaO. In this case, being “substantially free of” CaO means that the CaO content in a glass is less than 0.01 mol %.

(8) SrO

Similarly to MgO and CaO, SrO is characterized in that it suppresses an increase in the thermal expansion coefficient of the glass composition without causing a significant decrease in the strain point of the glass composition. SrO also improves the meltability of the glass composition. Therefore, the glass composition according to the present invention may contain SrO to improve the devitrification resistance and acid resistance. An SrO content, in the glass composition, equal to or less than a predetermined value can suppress a decrease in the devitrification resistance, an increase in the thermal expansion coefficient, and decreases in the acid resistance and durability. The SrO content in the glass composition according to the present invention is desirably 0.1 mol % or more, more desirably 0.2 mol % or more, and even more desirably 1.0 mol % or more. Also, the SrO content in the glass composition according to the present invention is desirably 15.0 mol % or less, more desirably 12.0 mol % or less, even more desirably 10.0 mol % or less, and particularly desirably 9.0 mol % or less. The glass composition according to the present invention may be substantially free of SrO.

(9) BaO

BaO contributes to adjustment of the etchability of a glass and has the effect of improving the phase separation properties, devitrification resistance, and chemical durability of the glass. Thus, the glass composition according to the present invention may contain an appropriate amount of BaO. The BaO content in the glass composition according to the present invention is desirably 0.1 mol % or more, more desirably 0.2 mol % or more, and even more desirably 0.5 mol % or more. Also, the BaO content in the glass composition according to the present invention is desirably 15.0 mol % or less, more desirably 12.0 mol % or less, even more desirably 10.0 mol % or less, and particularly desirably 5.0 mol % or less. The glass composition according to the present invention may be substantially free of BaO.

(10) Li₂O, Na₂O and K₂O

Alkali metal oxides (Li₂O, Na₂O and K₂O) are components that can greatly alter the properties of a glass. Incorporation of the alkali metal oxides in the glass composition significantly improves the meltability of the glass. Thus, the glass composition according to the present invention may contain the alkali metal oxides. However, they greatly affect the thermal expansion coefficient of the glass composition, and the contents of the alkali metal oxides therefore need to be adjusted in accordance with the intended use of the glass. In particular, when the alkali metal oxides are contained in a glass for use in the electronic engineering field, there is a possibility that the alkali components may diffuse into a semiconductor adjacent to the glass during a heat treatment process and the electrical insulation properties may be significantly deteriorated, and thus properties such as dielectric constant (c) and dielectric loss tangent (tan 6) may be adversely affected and high-frequency characteristics may be degraded. In the case where the glass composition according to the present invention contains the alkali metal oxides, it is possible to prevent the diffusion of the alkali components to parts adjacent to the glass board by coating, with another dielectric material, a surface of the glass board formed of the glass composition. This can solve some of the above-mentioned problems. As the method for coating the surface of the glass board, it is possible to use a known method examples of which include: a physical method such as sputtering or vapor-deposition of a dielectric material such as SiO₂; and a film formation method that uses a sol-gel process to form a film from a liquid phase material. The glass composition according to the present invention may be an alkali-free glass containing no alkali metal oxide, that is, an alkali-free glass in which the sum (Li₂O+Na₂O+K₂O) of the Li₂O, Na₂O and K₂O contents is 0 mol %. Further, the glass composition according to the present invention may be a low-alkali glass containing a slight amount of the alkali metal oxide(s). In this case, the content of the alkali metal oxide(s) in the low-alkali glass may be 0.0001 mol % or more, 0.0005 mol % or more, and 0.001 mol % or more. Also, the content of the alkali metal oxide(s) in the low-alkali glass is desirably less than 2.0 mol %, more desirably less than 1.0 mol %, even more desirably less than 0.1 mol %, particularly desirably less than 0.05 mol %, and most desirably less than 0.01 mol %.

(11) Fe₂O₃

Fe₂O₃ is also effective as a coloring component, and the glass composition according to the present invention may contain Fe₂O₃. In particular, by allowing the glass composition to contain TiO₂ and Fe₂O₃ in combination or TiO₂, CeO₂ and Fe₂O₃ in combination, it becomes easier to form modified portions in a glass by laser. When the glass composition according to the present invention contains CeO₂, the glass composition according to the present invention may be substantially free of Fe₂O₃. In this case, the Fe₂O₃ content in the glass composition according to the present invention is, for example, 0.007 mol % or less, desirably 0.005 mol % or less, and more desirably 0.001 mol % or less. The appropriate content of Fe₂O₃ in the glass composition according to the present invention is, for example, 0 to 1.0 mol %, and desirably 0.008 to 0.7 mol %, more desirably 0.01 to 0.4 mol %, and even more desirably 0.02 to 0.3 mol %.

(12) CeO₂

The glass composition according to the present invention may contain CeO₂ as a coloring component. In particular, combined use of CeO₂ with TiO₂ makes it easier to form modified portions in a glass by laser and makes it possible to manufacture a glass board with reduced variation in quality. When the glass composition according to the present invention contains Fe₂O₃, the glass composition may be substantially free of CeO₂. In this case, the CeO₂ content in the glass composition according to the present invention is, for example, 0.04 mol % or less, desirably 0.01 mol % or less, and more desirably 0.005 mol % or less. A CeO₂ content, in the glass composition, equal to or less than a predetermined value makes it possible to suppress an increase in the degree of coloring of a glass and to prevent deep modified portions from being unformed in the glass. The CeO₂ content in the glass composition according to the present invention is, for example, 0 to 3.0 mol %, desirably 0.05 to 2.5 mol %, more desirably 0.1 to 2.0 mol %, and even more desirably 0.2 to 0.9 mol %. CeO₂ is also effective as a refining agent, and its content can be adjusted according to need.

For example, MgO, CaO, SrO and BaO each are a component that greatly affects the thermal expansion coefficient of the glass composition, and high contents of these components in the glass composition are likely to increase the thermal expansion coefficient (CTE) of the glass composition. Therefore, MgO, CaO, SrO and BaO each can be contained in the glass composition according to the present invention considering their contents that exert the above-mentioned advantages. From such a viewpoint, the sum (MgO+CaO+SrO+BaO) of the MgO, CaO, SrO and BaO contents in the glass composition according to the present invention is desirably 5.0 mol % or more, more desirably 7.0 mol % or more, and even more desirably 9.0 mol % or more. Also, the sum (MgO+CaO+SrO+BaO) of the MgO, CaO, SrO and BaO contents in the glass composition according to the present invention is desirably 25.0 mol % or less, more desirably 22.0 mol % or less, and particularly desirably 20.0 mol % or less. On the other hand, B₂O₃, Al₂O₃ and ZnO slightly affect the thermal expansion coefficient (CTE) of the glass composition.

High MgO, SrO and BaO contents in the glass composition are likely to increase the variation in the CTE of the glass composition that occurs with temperature change. Therefore, MgO, SrO and BaO each can be contained in the glass composition according to the present invention considering their contents that exert the above-mentioned advantages. In contrast, high B₂O₃, Al₂O₃ and CaO contents in the glass composition are likely to decrease the variation in the CTE of the glass composition that occurs with temperature change. Therefore, in the glass composition according to the present invention, a molar ratio (MgO+SrO+BaO)/(B₂O₃+Al₂O₃+CaO) of the MgO, SrO and BaO contents relative to the B₂O₃, Al₂O₃ and CaO contents is desirably 0.10 or more, more desirably 0.20 or more, and even more desirably 0.25 or more. Also, a molar ratio (MgO+SrO+BaO)/(B₂O₃+Al₂O₃+CaO) of the MgO, SrO and BaO contents relative to the B₂O₃, Al₂O₃ and CaO contents is desirably 3.00 or less, more desirably 2.00 or less, and even more desirably 1.50 or less. This makes it possible to decrease the variation in the CTE of the glass composition that occurs with temperature change, so that it can be approximated to the variation in the CTE of single crystal silicon that occurs with temperature change. It should be noted that ZnO slightly affects the variation in the CTE of the glass composition that occurs with temperature change.

(13) Another Component

The glass composition according to the present invention may contain another component as long as it satisfies a relationship of (17.1×10⁻³×T+25.4)×10⁻⁷1° C.≤CTE (T)≤(17.1×10⁻³×T+31.4)×10⁻⁷1° C. in a temperature range of 0° C. to 100° C. The glass composition according to the present invention may contain a component such as SnO₂, La₂O₃ and Nb₂O₅ in some cases.

The glass composition according to the present invention can be formed into a glass board by a method such as a float process, a casting process, and a down-draw process.

### EXAMPLES

Hereinafter, the present invention will be described in more detail with examples. The present invention is not limited to the following examples.

<Fabrication of a Glass Sample>

Powder of each starting material was weighed and mixed to obtain approximately 200 g of mixed powder having a glass composition indicated in Tables 1 and 2, using an electronic balance (product name: FX-500i, available from A&D Company, Limited). The mixed powder was melted, stirred and degassed in a high temperature melting furnace (model number: NE1-2025D, available from Motoyama Co., Ltd.), and then the resultant was made into a glass block having dimensions of 50 mm×50 mm×10 mm in thickness by a casting process. Thereafter, the glass block was cooled slowly in a slow cooling furnace to remove a residual stress from the glass. Then, the glass block was processed into a small piece to have dimensions of 4 mm×4 mm×20 mm using a general-purpose cutting apparatus. Thus, a glass sample according to each of Examples was obtained. Also, a single crystal silicon sample processed into a small piece to have dimensions of 4 mm×4 mm×20 mm was prepared.

<Measurement of Average Thermal Expansion Coefficient>

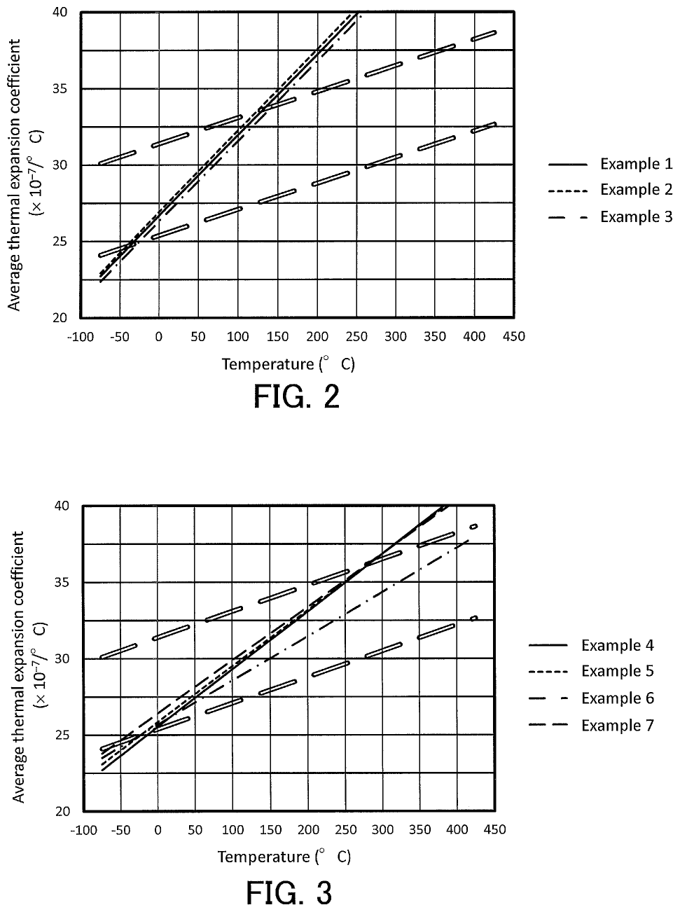

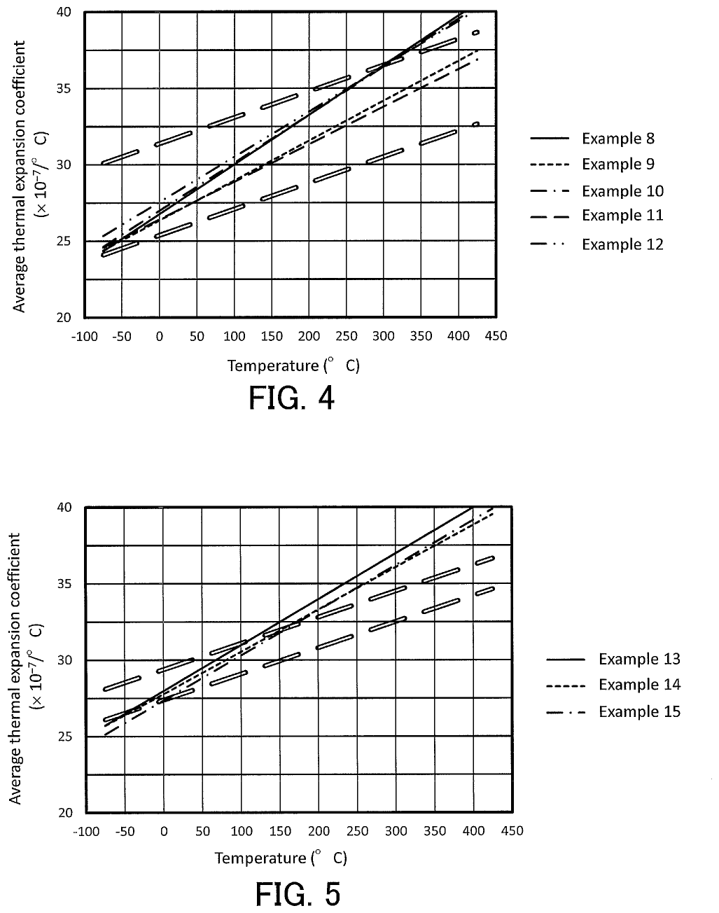

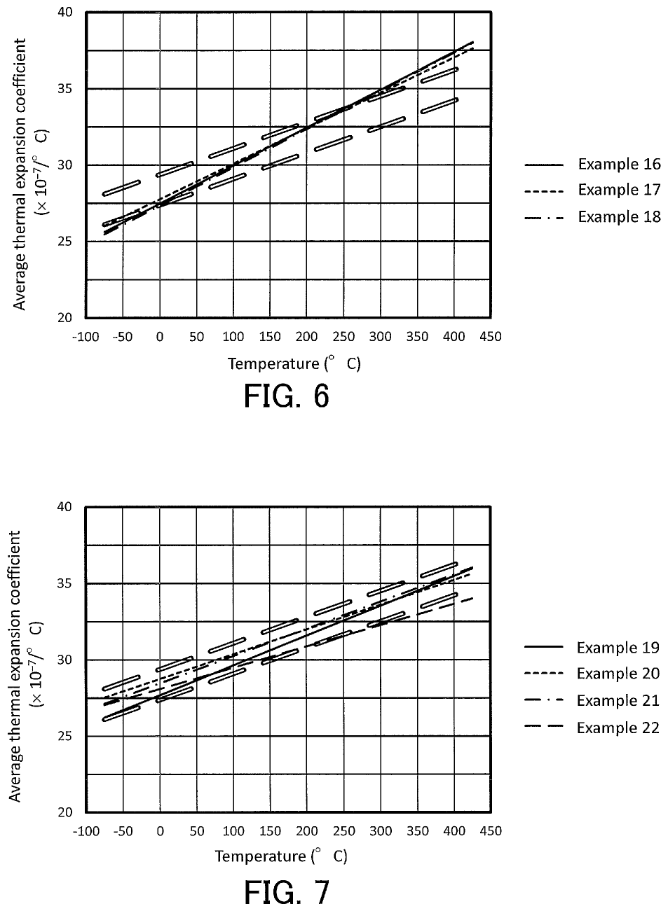

The glass sample according to each of Examples and the single crystal silicon sample were measured for length at a predetermined temperature under the conditions that the measurement temperature range was 100° C. to 500° C. and the temperature rise rate was at 5° C./min, under an atmospheric pressure, in compliance with Japanese Industrial Standard JIS R 3102-1995 (testing method for average linear thermal expansion of glass) using a thermomechanical analyzer (product name: TMA 402F1 Hyperion, available from NETZSCH Japan K.K.). The average thermal expansion coefficient CTE (T), in a temperature range of 50° C. to T° C., of the glass sample according to each of Examples and that of the single crystal silicon sample were calculated by the above-mentioned equation (1), based on the length of each sample at a temperature of 50° C. and the length of each sample at a temperature of T° C. The average thermal expansion coefficient CTE (T) of the glass sample according to each of Examples and that of the single crystal silicon sample were determined in twenty five degree intervals in a range of −75° C. to 425° C. Table 3, Table 4 and FIGS. 2 to 7 show the results of the glass sample according to each of Examples. Table 5 shows the results of the sample of single crystal silicon with orientation (100). It should be noted that CTE (50) of the glass sample according to each of Examples and that of the single crystal silicon sample were determined by arithmetically averaging CTE (25) and CTE (75).

In Table 5, “CTE (T)−(3×10⁻⁷1° C.)”, “CTE (T)−(1×10⁻⁷1° C.)”, “CTE (T)+(1×10⁻⁷1° C.)” and “CTE (T)+(3×10⁻⁷1° C.)” are respectively the value obtained by subtracting (3×10⁻⁷/° C.) from CTE (T), the value obtained by subtracting (1×10⁻⁷/° C.) from CTE (T), the value obtained by adding (1×10⁻⁷/° C.) to CTE (T) and the value obtained by adding (3×10⁻⁷/° C.) to CTE (T). In each of FIGS. 2 to 4, the area determined by the two hollow dashed lines represents the range of CTE (T) of the single crystal silicon sample±3×10⁻⁷1° C. In each of FIGS. 2 to 4, the lower one of the two hollow dashed lines can be expressed as CTE (T)=(17.1×10⁻³×T+25.4)×10⁻⁷1° C., and the upper one can be expressed as CTE (T)=(17.1×10⁻³×T+31.4)×10⁻⁷/° C. In each of FIGS. 5 to 7, the area determined by the two hollow dashed lines represents the range of CTE(T) of the single crystal silicon sample±1×10⁻⁷/° C. In each of FIGS. 5 to 7, the lower one of the two hollow dashed lines can be expressed as CTE (T)=(17.1×10⁻³×T+27.4)×10⁻⁷/° C., and the upper one can be expressed as CTE (T)=(17.1×10⁻³×T+29.4)×10⁻⁷1° C.

<Calculation of Warpage Amount δ>

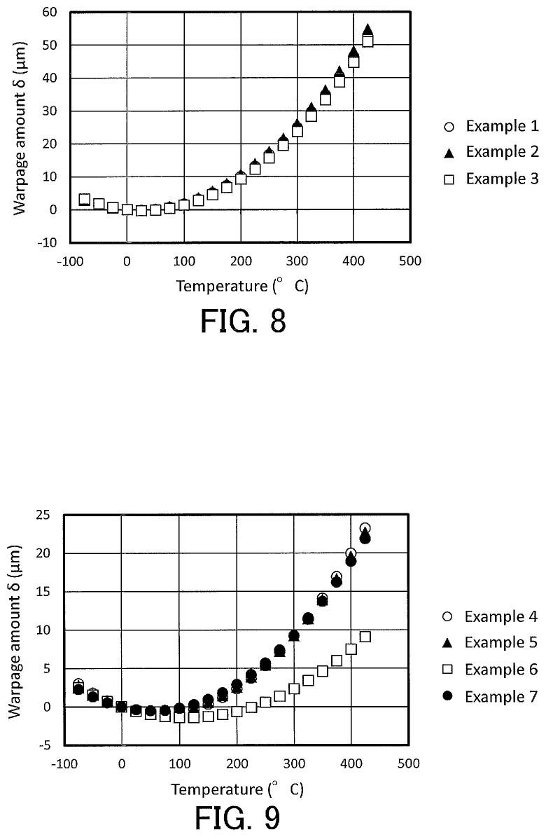

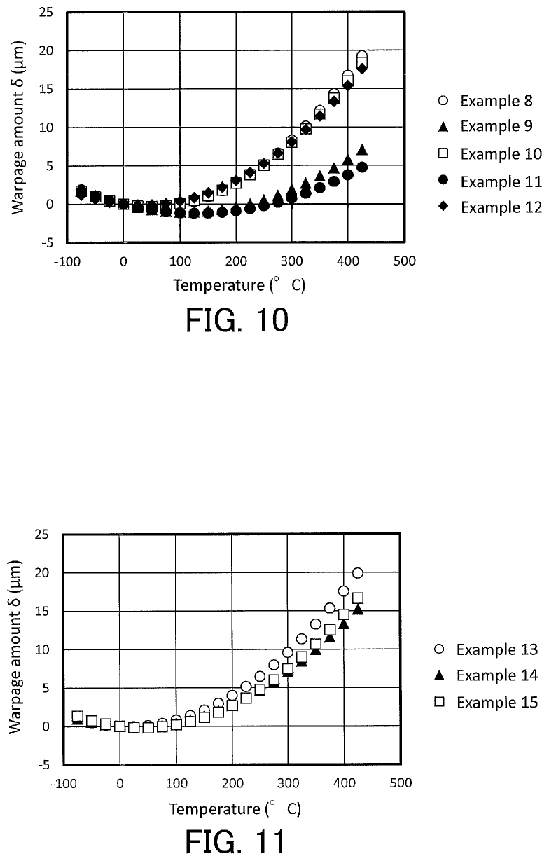

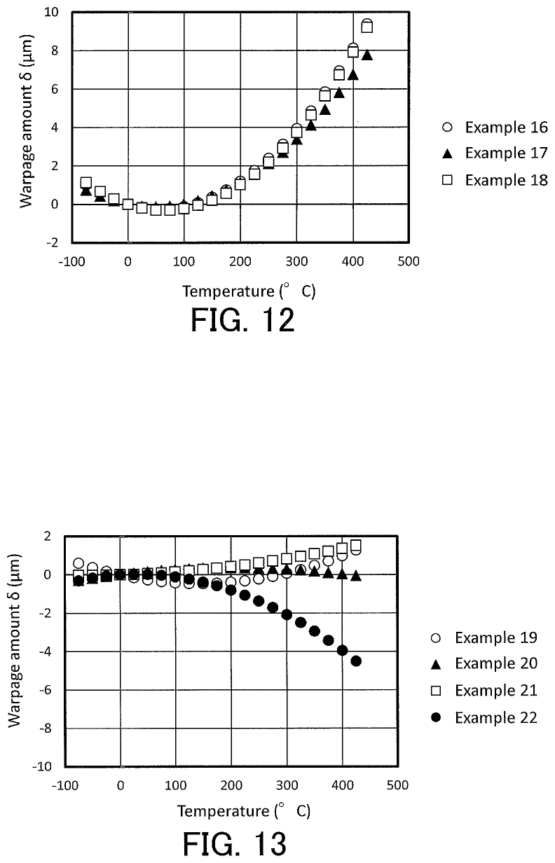

The warpage amount δ of the glass sample according to each of Examples was calculated by the above-mentioned equation (2), based on the results of the average thermal expansion coefficient CTE (T) of the glass sample according to each of Examples and that of the single crystal silicon sample. Table 6 and FIGS. 8 to 13 show the results. E₁ is a Young's modulus of the glass sample according to each of Examples, which was measured in compliance with JIS R 1602-1995 and used for the calculation of the warpage amount δ. E₂ is a Young's modulus of the single crystal silicon, and E₂=130 GPa, which is the value of single crystal silicon with orientation (100), was used herein.

As shown in Table 3, Table 4, and FIGS. 2 to 4, all of the thermal expansion coefficient CTE (T) of the glass sample according to each of Examples 1 to 3 in a temperature range of 0° C. to 100° C., the thermal expansion coefficient CTE (T) of the glass sample according to each of Examples 4 to 7 in a temperature range of 0° C. to 250° C., the thermal expansion coefficient CTE (T) of the glass sample according to each of Examples 8 to 12 in a temperature range of −70° C. to 300° C., and the thermal expansion coefficient CTE (T) of the glass sample according to each of Examples 9 to 11 in a temperature range of −75° C. to 425° C. satisfied a relationship of (17.1×10⁻³×T+25.4)×10⁻⁷/° C.≤CTE (T)≤(17.1×10⁻³×T+31.4)×10⁻⁷1° C.

As shown in Table 4 and FIGS. 5 to 7, all of the thermal expansion coefficient CTE (T) of the glass sample according to each of Examples 13 to 15 and Example 22 in a temperature range of 0° C. to 100° C., the thermal expansion coefficient CTE (T) of the glass sample according to each of Examples 16 to 18 in a temperature range of 0° C. to 250° C., the thermal expansion coefficient CTE (T) of the glass sample according to each of Examples 19 to 21 in a temperature range of −70° C. to 300° C., and the thermal expansion coefficient CTE (T) of the glass sample according to each of Examples 19 to 21 in a temperature range of −75° C. to 425° C. satisfied a relationship of (17.1×10⁻³×T+27.4)×10⁻⁷/° C.≤CTE (T)≤(17.1×10⁻³×T+29.4)×10⁻⁷/° C. in a temperature range of 0° C. to 100° C.

As shown in Table 6 and FIGS. 8 to 13, the warpage amount δ in a temperature range of 0° C. to 100° C. calculated on the glass sample according to each of Examples 1 to 22 satisfied a relationship of −5 μm≤δ≤5 μm. As shown in Table 6 and FIGS. 9 to 13, the warpage amount δ in a temperature range of −70° C. to 300° C. calculated on the glass sample according to each of Examples 4 to 22 satisfied a relationship of −5 μm≤δ≤10 μm. The warpage amount δ in a temperature range of −70° C. to 400° C. calculated on the glass sample according to each of Examples 4 to 22 satisfied a relationship of −5 μm≤δ≤20 μm.

TABLE 1

| | Exam- | Exam- | Exam- | Exam- | Exam- | Exam- | Exam- | Exam- | Exam- | Exam- | Exam- | Exam- |
|---|---|---|---|---|---|---|---|---|---|---|---|---|
| | ple 1 | ple 2 | ple 3 | ple 4 | ple 5 | ple 6 | ple 7 | ple 8 | ple 9 | ple 10 | ple 11 | ple 12 |
| SiO₂ [mol %] | 61.0 | 50.5 | 52.5 | 61.0 | 52.0 | 56.4 | 52.5 | 59.0 | 58.8 | 51.0 | 55.7 | 51.5 |
| B₂O₃ [mol %] | 2.0 | 2.0 | 4.0 | 4.0 | 5.0 | 4.2 | 8.0 | 5.0 | 4.2 | 7.0 | 7.5 | 10.0 |
| Al₂O₃ [mol %] | 15.0 | 15.0 | 12.0 | 15.0 | 15.0 | 17.4 | 12.0 | 15.0 | 15.0 | 15.0 | 15.0 | 12.0 |
| TiO₂ [mol %] | 3.0 | 6.0 | 6.0 | 3.0 | 4.0 | 4.0 | 4.0 | 3.0 | 4.0 | 3.0 | 4.0 | 3.0 |
| ZnO [mol %] | 3.0 | 7.0 | 7.0 | 3.0 | 7.0 | 3.7 | 7.0 | 3.0 | 3.7 | 7.0 | 3.7 | 7.0 |
| MgO [mol %] | 9.0 | 10.0 | 10.0 | 9.0 | 10.0 | 10.0 | 10.0 | 9.0 | 10.0 | 10.0 | 10.0 | 10.0 |
| CaO [mol %] | 0.0 | 1.0 | 1.0 | 2.0 | 2.0 | 4.0 | 2.0 | 3.0 | 4.0 | 2.0 | 4.0 | 2.0 |
| SrO [mol %] | 5.0 | 8.0 | 7.0 | 2.0 | 5.0 | 0.4 | 4.5 | 2.5 | 0.4 | 5.0 | 0.2 | 4.5 |
| BaO [mol %] | 2.0 | 0.5 | 0.5 | 1.0 | 0.0 | 0.0 | 0.0 | 0.5 | 0.0 | 0.0 | 0.0 | 0.0 |
| Fe₂O₃ [mol %] | 0.01 | 0.01 | 0.01 | 0.01 | 0.01 | 0.01 | 0.01 | 0.01 | 0.01 | 0.01 | 0.01 | 0.01 |
| Total | 100.0 | 100.0 | 100.0 | 100.0 | 100.0 | 100.0 | 100.0 | 100.0 | 100.0 | 100.0 | 100.0 | 100.0 |
| MgO + CaO + | 16.0 | 19.5 | 18.5 | 14.0 | 17.0 | 14.4 | 16.5 | 15.0 | 14.4 | 17.0 | 14.2 | 16.5 |
| SrO + BaO | | | | | | | | | | | | |
| [mol %] | | | | | | | | | | | | |
| (MgO + SrO + | 0.94 | 1.03 | 1.03 | 0.57 | 0.68 | 0.41 | 0.66 | 0.52 | 0.45 | 0.63 | 0.38 | 0.60 |
| BaO)/(B₂O₃ + | | | | | | | | | | | | |
| Al₂O₃ + CaO) | | | | | | | | | | | | |

TABLE 2

| | Example | Example | Example | Example | Example | Example | Example | Example | Example | Example |
|---|---|---|---|---|---|---|---|---|---|---|
| | 13 | 14 | 15 | 16 | 17 | 18 | 19 | 20 | 21 | 22 |
| SiO₂ [mol %] | 63.0 | 52.0 | 54.0 | 61.0 | 52.0 | 54.0 | 60.6 | 52.5 | 53.0 | 60.9 |
| B₂O₃ [mol %] | 6.0 | 10.0 | 11.0 | 8.0 | 10.0 | 11.0 | 10.0 | 12.0 | 12.0 | 12.0 |
| Al₂O₃ [mol %] | 15.0 | 15.0 | 12.0 | 15.0 | 15.0 | 12.0 | 15.0 | 15.0 | 12.0 | 11.0 |
| TiO₂ [mol %] | 3.0 | 7.0 | 7.0 | 3.0 | 4.0 | 4.0 | 3.0 | 3.0 | 2.5 | 3.0 |
| ZnO [mol %] | 1.0 | 4.0 | 4.0 | 1.0 | 5.0 | 5.0 | 1.0 | 5.0 | 7.0 | 3.0 |
| MgO [mol %] | 6.0 | 8.0 | 8.0 | 6.0 | 10.0 | 10.0 | 5.0 | 8.0 | 10.0 | 4.3 |
| CaO [mol %] | 3.0 | 3.0 | 3.0 | 3.0 | 3.0 | 3.0 | 3.0 | 3.0 | 3.5 | 3.0 |
| SrO [mol %] | 2.0 | 1.0 | 1.0 | 2.5 | 1.0 | 1.0 | 2.0 | 1.5 | 0.0 | 3.0 |
| BaO [mol %] | 1.0 | 0.0 | 0.0 | 0.5 | 0.0 | 0.0 | 0.4 | 0.0 | 0.0 | 0.0 |
| Fe₂O₃ [mol %] | 0.01 | 0.01 | 0.01 | 0.01 | 0.01 | 0.01 | 0.01 | 0.01 | 0.01 | 0.01 |
| Total | 100.0 | 100.0 | 100.0 | 100.0 | 100.0 | 100.0 | 100.0 | 100.0 | 100.0 | 100.0 |
| MgO + CaO + | 12.0 | 12.0 | 12.0 | 12.0 | 14.0 | 14.0 | 10.4 | 12.5 | 13.5 | 10.2 |
| SrO + BaO | | | | | | | | | | |
| [mol %] | | | | | | | | | | |
| (MgO + SrO + | 0.38 | 0.32 | 0.35 | 0.35 | 0.39 | 0.42 | 0.26 | 0.32 | 0.36 | 0.28 |
| BaO)/(B₂O₃ + | | | | | | | | | | |
| Al₂O₃ + CaO) | | | | | | | | | | |

TABLE 3

| | Example | Example | Example | Example | Example | Example | Example | Example | Example | Example | Example |
|---|---|---|---|---|---|---|---|---|---|---|---|
| | 1 | 2 | 3 | 4 | 5 | 6 | 7 | 8 | 9 | 10 | 11 |
| Temperature T | CTE (T) | CTE (T) | CTE (T) | CTE (T) | CTE (T) | CTE (T) | CTE (T) | CTE (T) | CTE (T) | CTE (T) | CTE (T) |
| [° C.] | [10⁻⁷/° C.] | [10⁻⁷/° C.] | [10⁻⁷/° C.] | [10⁻⁷/° C.] | [10⁻⁷/° C.] | [10⁻⁷/° C.] | [10⁻⁷/° C.] | [10⁻⁷/° C.] | [10⁻⁷/° C.] | [10⁻⁷/° C.] | [10⁻⁷/° C.] |
| −75 | 22.7 | 22.9 | 22.4 | 22.7 | 23.1 | 23.5 | 23.8 | 24.3 | 24.4 | 24.6 | 24.6 |
| −50 | 24.0 | 24.3 | 23.7 | 23.7 | 24.0 | 24.2 | 24.7 | 25.2 | 25.1 | 25.4 | 25.2 |
| −25 | 25.4 | 25.6 | 25.0 | 24.6 | 24.9 | 25.0 | 25.5 | 26.0 | 25.7 | 26.2 | 25.8 |
| 0 | 26.7 | 26.9 | 26.3 | 25.5 | 25.8 | 25.7 | 26.4 | 26.8 | 26.4 | 27.0 | 26.4 |
| 25 | 28.0 | 28.3 | 27.6 | 26.5 | 26.8 | 26.4 | 27.3 | 27.6 | 27.0 | 27.8 | 27.0 |
| 50 | 29.3 | 29.6 | 28.9 | 27.4 | 27.7 | 27.1 | 28.2 | 28.4 | 27.7 | 28.6 | 27.7 |
| 75 | 30.6 | 30.9 | 30.2 | 28.4 | 28.6 | 27.8 | 29.0 | 29.2 | 28.3 | 29.3 | 28.3 |
| 100 | 32.0 | 32.3 | 31.6 | 29.3 | 29.5 | 28.6 | 29.9 | 30.0 | 29.0 | 30.1 | 28.9 |
| 125 | 33.3 | 33.6 | 32.9 | 30.3 | 30.4 | 29.3 | 30.8 | 30.8 | 29.6 | 30.9 | 29.5 |
| 150 | 34.6 | 34.9 | 34.2 | 31.2 | 31.3 | 30.0 | 31.6 | 31.6 | 30.3 | 31.7 | 30.1 |
| 175 | 35.9 | 36.2 | 35.5 | 32.1 | 32.3 | 30.7 | 32.5 | 32.5 | 30.9 | 32.5 | 30.7 |
| 200 | 37.2 | 37.6 | 36.8 | 33.1 | 33.2 | 31.5 | 33.4 | 33.3 | 31.6 | 33.3 | 31.3 |
| 225 | 38.6 | 38.9 | 38.1 | 34.0 | 34.1 | 32.2 | 34.3 | 34.1 | 32.2 | 34.1 | 32.0 |
| 250 | 39.9 | 40.2 | 39.4 | 35.0 | 35.0 | 32.9 | 35.1 | 34.9 | 32.9 | 34.8 | 32.6 |
| 275 | 41.2 | 41.6 | 40.7 | 35.9 | 35.9 | 33.6 | 36.0 | 35.7 | 33.5 | 35.6 | 33.2 |
| 300 | 42.5 | 42.9 | 42.1 | 36.9 | 36.8 | 34.4 | 36.9 | 36.5 | 34.2 | 36.4 | 33.8 |
| 325 | 43.8 | 44.2 | 43.4 | 37.8 | 37.8 | 35.1 | 37.7 | 37.3 | 34.8 | 37.2 | 34.4 |
| 350 | 45.1 | 45.6 | 44.7 | 38.7 | 38.7 | 35.8 | 38.6 | 38.1 | 35.5 | 38.0 | 35.0 |
| 375 | 46.5 | 46.9 | 46.0 | 39.7 | 39.6 | 36.5 | 39.5 | 38.9 | 36.1 | 38.8 | 35.6 |
| 400 | 47.8 | 48.2 | 47.3 | 40.6 | 40.5 | 37.2 | 40.3 | 39.8 | 36.8 | 39.5 | 36.2 |
| 425 | 49.1 | 49.6 | 48.6 | 41.6 | 41.4 | 38.0 | 41.2 | 40.6 | 37.4 | 40.3 | 36.9 |

TABLE 4

| | Example | Example | Example | Example | Example | Example | Example | Example | Example | Example | Example |
|---|---|---|---|---|---|---|---|---|---|---|---|
| | 12 | 13 | 14 | 15 | 16 | 17 | 18 | 19 | 20 | 21 | 22 |
| Temperature T | CTE (T) | CTE (T) | CTE (T) | CTE (T) | CTE (T) | CTE (T) | CTE (T) | CTE (T) | CTE (T) | CTE (T) | CTE (T) |
| [° C.] | [10⁻⁷/° C.] | [10⁻⁷/° C.] | [10⁻⁷/° C.] | [10⁻⁷/° C.] | [10⁻⁷/° C.] | [10⁻⁷/° C.] | [10⁻⁷/° C.] | [10⁻⁷/° C.] | [10⁻⁷/° C.] | [10⁻⁷/° C.] | [10⁻⁷/° C.] |
| −75 | 25.3 | 25.7 | 25.7 | 25.1 | 25.6 | 26.0 | 25.5 | 26.2 | 27.5 | 27.1 | 27.1 |
| −50 | 26.1 | 26.5 | 26.4 | 25.9 | 26.2 | 26.6 | 26.1 | 26.7 | 27.9 | 27.6 | 27.4 |
| −25 | 26.8 | 27.2 | 27.1 | 26.6 | 26.9 | 27.2 | 26.7 | 27.2 | 28.3 | 28.0 | 27.7 |
| 0 | 27.6 | 28.0 | 27.8 | 27.4 | 27.5 | 27.8 | 27.3 | 27.7 | 28.8 | 28.5 | 28.1 |
| 25 | 28.3 | 28.7 | 28.5 | 28.1 | 28.1 | 28.4 | 28.0 | 28.2 | 29.2 | 28.9 | 28.4 |
| 50 | 29.0 | 29.5 | 29.2 | 28.8 | 28.7 | 28.9 | 28.6 | 28.7 | 29.6 | 29.4 | 28.8 |
| 75 | 29.8 | 30.2 | 29.9 | 29.6 | 29.3 | 29.5 | 29.2 | 29.2 | 30.0 | 29.8 | 29.1 |
| 100 | 30.5 | 31.0 | 30.5 | 30.3 | 30.0 | 30.1 | 29.9 | 29.6 | 30.4 | 30.2 | 29.5 |
| 125 | 31.3 | 31.7 | 31.2 | 31.0 | 30.6 | 30.7 | 30.5 | 30.1 | 30.8 | 30.7 | 29.8 |
| 150 | 32.0 | 32.5 | 31.9 | 31.8 | 31.2 | 31.3 | 31.1 | 30.6 | 31.2 | 31.1 | 30.2 |
| 175 | 32.7 | 33.2 | 32.6 | 32.5 | 31.8 | 31.8 | 31.7 | 31.1 | 31.6 | 31.6 | 30.5 |
| 200 | 33.5 | 34.0 | 33.3 | 33.2 | 32.5 | 32.4 | 32.4 | 31.6 | 32.0 | 32.0 | 30.9 |
| 225 | 34.2 | 34.7 | 34.0 | 34.0 | 33.1 | 33.0 | 33.0 | 32.1 | 32.4 | 32.5 | 31.2 |
| 250 | 35.0 | 35.5 | 34.7 | 34.7 | 33.7 | 33.6 | 33.6 | 32.6 | 32.8 | 32.9 | 31.6 |
| 275 | 35.7 | 36.2 | 35.4 | 35.5 | 34.3 | 34.2 | 34.2 | 33.1 | 33.2 | 33.4 | 31.9 |
| 300 | 36.4 | 37.0 | 36.1 | 36.2 | 34.9 | 34.7 | 34.9 | 33.5 | 33.6 | 33.8 | 32.3 |
| 325 | 37.2 | 37.7 | 36.8 | 36.9 | 35.6 | 35.3 | 35.5 | 34.0 | 34.0 | 34.3 | 32.6 |
| 350 | 37.9 | 38.5 | 37.4 | 37.7 | 36.2 | 35.9 | 36.1 | 34.5 | 34.4 | 34.7 | 33.0 |
| 375 | 38.6 | 39.2 | 38.1 | 38.4 | 36.8 | 36.5 | 36.7 | 35.0 | 34.8 | 35.1 | 33.3 |
| 400 | 39.4 | 40.0 | 38.8 | 39.1 | 37.4 | 37.0 | 37.4 | 35.5 | 35.2 | 35.6 | 33.7 |
| 425 | 40.1 | 40.7 | 39.5 | 39.9 | 38.0 | 37.6 | 38.0 | 36.0 | 35.6 | 36.0 | 34.0 |

TABLE 5

| | Single crystal silicon | Calculated value based on the CTE (T) value of single crystal silicon | | | |
|---|---|---|---|---|---|
| Temperature T | CTE (T) | CTE (T) − | CTE (T) − | CTE (T) + | CTE (T) + |
| [° C.] | [×10⁻⁷/° C.] | (3 × 10⁻⁷/° C.) | (1 × 10⁻⁷/° C.) | (1 × 10⁻⁷/° C.) | (3 × 10⁻⁷/° C.) |
| −75 | 27.1 | 24.1 | 26.1 | 28.1 | 30.1 |
| −50 | 27.5 | 24.5 | 26.5 | 28.5 | 30.5 |
| −25 | 28.0 | 25.0 | 27.0 | 29.0 | 31.0 |
| 0 | 28.4 | 25.4 | 27.4 | 29.4 | 31.4 |
| 25 | 28.8 | 25.8 | 27.8 | 29.8 | 31.8 |
| 50 | 29.2 | 26.2 | 28.2 | 30.2 | 32.2 |
| 75 | 29.7 | 26.7 | 28.7 | 30.7 | 32.7 |
| 100 | 30.1 | 27.1 | 29.1 | 31.1 | 33.1 |
| 125 | 30.5 | 27.5 | 29.5 | 31.5 | 33.5 |
| 150 | 30.9 | 27.9 | 29.9 | 31.9 | 33.9 |
| 175 | 31.4 | 28.4 | 30.4 | 32.4 | 34.4 |
| 200 | 31.8 | 28.8 | 30.8 | 32.8 | 34.8 |
| 225 | 32.2 | 29.2 | 31.2 | 33.2 | 35.2 |
| 250 | 32.7 | 29.7 | 31.7 | 33.7 | 35.7 |
| 275 | 33.1 | 30.1 | 32.1 | 34.1 | 36.1 |
| 300 | 33.5 | 30.5 | 32.5 | 34.5 | 36.5 |
| 325 | 33.9 | 30.9 | 32.9 | 34.9 | 36.9 |
| 350 | 34.4 | 31.4 | 33.4 | 35.4 | 37.4 |
| 375 | 34.8 | 31.8 | 33.8 | 35.8 | 37.8 |
| 400 | 35.2 | 32.2 | 34.2 | 36.2 | 38.2 |
| 425 | 35.6 | 32.6 | 34.6 | 36.6 | 38.6 |

TABLE 6

| | Example | Example | Example | Example | Example | Example | Example | Example | Example | Example | Example |
|---|---|---|---|---|---|---|---|---|---|---|---|
| Temperature T | 1 | 2 | 3 | 4 | 5 | 6 | 7 | 8 | 9 | 10 | 11 |
| (° C.) | δ [μm] | δ [μm] | δ [μm] | δ [μm] | δ [μm] | δ [μm] | δ [μm] | δ [μm] | δ [μm] | δ [μm] | δ [μm] |
| −75 | 3.03 | 2.89 | 3.27 | 3.04 | 2.78 | 2.49 | 2.29 | 1.91 | 1.87 | 1.70 | 1.75 |
| −50 | 1.61 | 1.51 | 1.77 | 1.79 | 1.62 | 1.52 | 1.32 | 1.10 | 1.14 | 0.97 | 1.08 |
| −25 | 0.60 | 0.55 | 0.68 | 0.78 | 0.70 | 0.69 | 0.56 | 0.46 | 0.52 | 0.40 | 0.50 |
| 0 | 0.00 | 0.00 | 0.00 | 0.00 | 0.00 | 0.00 | 0.00 | 0.00 | 0.00 | 0.00 | 0.00 |
| 25 | −0.19 | −0.13 | −0.27 | −0.54 | −0.47 | −0.56 | −0.35 | −0.28 | −0.42 | −0.24 | −0.41 |
| 50 | 0.04 | 0.16 | −0.14 | −0.84 | −0.72 | −0.98 | −0.50 | −0.39 | −0.73 | −0.31 | −0.73 |
| 75 | 0.68 | 0.87 | 0.40 | −0.90 | −0.74 | −1.26 | −0.44 | −0.32 | −0.94 | −0.22 | −0.97 |
| 100 | 1.72 | 1.99 | 1.35 | −0.72 | −0.54 | −1.41 | −0.18 | −0.07 | −1.04 | 0.04 | −1.12 |
| 125 | 3.18 | 3.54 | 2.71 | −0.31 | −0.11 | −1.42 | 0.28 | 0.36 | −1.04 | 0.46 | −1.19 |
| 150 | 5.06 | 5.50 | 4.48 | 0.34 | 0.55 | −1.29 | 0.96 | 0.96 | −0.94 | 1.04 | −1.16 |
| 175 | 7.34 | 7.88 | 6.66 | 1.23 | 1.43 | −1.03 | 1.83 | 1.74 | −0.73 | 1.80 | −1.06 |
| 200 | 10.04 | 10.67 | 9.24 | 2.36 | 2.54 | −0.63 | 2.91 | 2.70 | −0.42 | 2.71 | −0.86 |
| 225 | 13.14 | 13.89 | 12.24 | 3.73 | 3.87 | −0.10 | 4.20 | 3.83 | −0.01 | 3.79 | −0.58 |
| 250 | 16.66 | 17.52 | 15.64 | 5.33 | 5.43 | 0.57 | 5.69 | 5.14 | 0.51 | 5.04 | −0.22 |
| 275 | 20.59 | 21.57 | 19.45 | 7.17 | 7.21 | 1.38 | 7.39 | 6.63 | 1.13 | 6.45 | 0.24 |
| 300 | 24.93 | 26.04 | 23.67 | 9.25 | 9.22 | 2.32 | 9.29 | 8.30 | 1.86 | 8.03 | 0.78 |
| 325 | 29.69 | 30.93 | 28.30 | 11.57 | 11.46 | 3.40 | 11.39 | 10.14 | 2.69 | 9.77 | 1.40 |
| 350 | 34.85 | 36.23 | 33.33 | 14.13 | 13.92 | 4.62 | 13.70 | 12.16 | 3.62 | 11.68 | 2.11 |
| 375 | 40.43 | 41.96 | 38.78 | 16.92 | 16.61 | 5.97 | 16.22 | 14.36 | 4.66 | 13.75 | 2.91 |
| 400 | 46.42 | 48.10 | 44.63 | 19.96 | 19.53 | 7.46 | 18.94 | 16.73 | 5.80 | 15.98 | 3.80 |
| 425 | 52.82 | 54.66 | 50.89 | 23.23 | 22.67 | 9.09 | 21.86 | 19.29 | 7.05 | 18.38 | 4.77 |
| | Example | Example | Example | Example | Example | Example | Example | Example | Example | Example | Example |
| Temperature T | 12 | 13 | 14 | 15 | 16 | 17 | 18 | 19 | 20 | 21 | 22 |
| (° C.) | δ [μm] | δ [μm] | δ [μm] | δ [μm] | δ [μm] | δ [μm] | δ [μm] | δ [μm] | δ [μm] | δ [μm] | δ [μm] |
| −75 | 1.22 | 0.95 | 0.97 | 1.36 | 1.02 | 0.74 | 1.13 | 0.61 | −0.30 | −0.02 | −0.30 |
| −50 | 0.67 | 0.48 | 0.52 | 0.76 | 0.59 | 0.42 | 0.66 | 0.38 | −0.19 | −0.02 | −0.17 |
| −25 | 0.26 | 0.17 | 0.20 | 0.31 | 0.25 | 0.18 | 0.29 | 0.17 | −0.09 | −0.02 | −0.06 |
| 0 | 0.00 | 0.00 | 0.00 | 0.00 | 0.00 | 0.00 | 0.00 | 0.00 | 0.00 | 0.00 | 0.00 |
| 25 | −0.12 | −0.02 | −0.08 | −0.17 | −0.16 | −0.11 | −0.19 | −0.15 | 0.08 | 0.02 | 0.03 |
| 50 | −0.09 | 0.11 | −0.04 | −0.19 | −0.24 | −0.14 | −0.30 | −0.26 | 0.15 | 0.06 | 0.02 |
| 75 | 0.08 | 0.39 | 0.13 | −0.07 | −0.22 | −0.11 | −0.31 | −0.36 | 0.21 | 0.10 | −0.02 |
| 100 | 0.39 | 0.82 | 0.41 | 0.19 | −0.11 | 0.00 | −0.22 | −0.42 | 0.26 | 0.14 | −0.11 |
| 125 | 0.85 | 1.39 | 0.82 | 0.60 | 0.08 | 0.17 | −0.05 | −0.45 | 0.29 | 0.20 | −0.22 |
| 150 | 1.45 | 2.12 | 1.35 | 1.14 | 0.36 | 0.42 | 0.21 | −0.46 | 0.32 | 0.26 | −0.38 |
| 175 | 2.20 | 2.99 | 2.00 | 1.84 | 0.74 | 0.74 | 0.57 | −0.44 | 0.34 | 0.34 | −0.57 |
| 200 | 3.09 | 4.02 | 2.77 | 2.67 | 1.20 | 1.12 | 1.02 | −0.39 | 0.35 | 0.42 | −0.80 |
| 225 | 4.12 | 5.19 | 3.67 | 3.65 | 1.75 | 1.58 | 1.56 | −0.32 | 0.34 | 0.51 | −1.06 |
| 250 | 5.30 | 6.51 | 4.68 | 4.77 | 2.39 | 2.11 | 2.19 | −0.22 | 0.33 | 0.61 | −1.37 |
| 275 | 6.62 | 7.98 | 5.82 | 6.03 | 3.12 | 2.71 | 2.92 | −0.09 | 0.31 | 0.71 | −1.70 |
| 300 | 8.09 | 9.60 | 7.08 | 7.44 | 3.94 | 3.37 | 3.73 | 0.07 | 0.27 | 0.83 | −2.08 |
| 325 | 9.70 | 11.36 | 8.46 | 8.99 | 4.85 | 4.11 | 4.64 | 0.26 | 0.23 | 0.95 | −2.49 |
| 350 | 11.45 | 13.28 | 9.96 | 10.68 | 5.85 | 4.92 | 5.64 | 0.47 | 0.17 | 1.08 | −2.94 |
| 375 | 13.35 | 15.34 | 11.59 | 12.52 | 6.94 | 5.80 | 6.74 | 0.71 | 0.11 | 1.22 | −3.42 |
| 400 | 15.39 | 17.56 | 13.34 | 14.50 | 8.12 | 6.75 | 7.92 | 0.98 | 0.03 | 1.36 | −3.94 |
| 425 | 17.58 | 19.92 | 15.20 | 16.62 | 9.38 | 7.77 | 9.19 | 1.28 | −0.05 | 1.52 | −4.50 |

1. A glass composition comprising SiO₂, B₂O₃, Al₂O₃, an alkaline-earth metal oxide and another metal oxide, wherein
when an average thermal expansion coefficient of the glass composition in a temperature range of 50° C. to T° C. is expressed as CTE (T),
a relationship of (17.1×10⁻³×T+25.4)×10⁻7° C.≤CTE (T)≤(17.1×10⁻³×T+31.4)×10⁻7° C. is satisfied in a temperature range of 0° C. to 100° C.

2. The glass composition according to claim 1, wherein a relationship of (17.1×10⁻³×T+25.4)×10⁻7° C.≤CTE (T)≤(17.1×10⁻³×T+31.4)×10⁻7° C. is satisfied in a temperature range of 0° C. to 250° C.

3. The glass composition according to claim 2, wherein a relationship of (17.1×10⁻³×T+25.4)×10⁻7° C.≤CTE (T)≤(17.1×10⁻³×T+31.4)×10⁻7° C. is satisfied in a temperature range of −70° C. to 300° C.

4. The glass composition according to claim 1, wherein a relationship of (17.1×10⁻³×T+27.4)×10⁻7° C.≤CTE (T)≤(17.1×10⁻³×T+29.4)×10⁻7° C. is satisfied in a temperature range of 0° C. to 100° C.

5. The glass composition according to claim 4, wherein a relationship of (17.1×10⁻³×T+27.4)×10⁻7° C.≤CTE (T)≤(17.1×10⁻³×T+29.4)×10⁻7° C. is satisfied in a temperature range of 0° C. to 250° C.

6. The glass composition according to claim 5, wherein a relationship of (17.1×10⁻³×T+27.4)×10⁻⁷/° C.≤CTE (T)≤(17.1×10⁻³×T+29.4)×10⁻⁷/° C. is satisfied in a temperature range of −70° C. to 300° C.

7. The glass composition according to claim 1, wherein a content of an alkali metal oxide in the glass composition, in mol %, is less than 2.0 mol %.

8. The glass composition according to claim 1, the glass composition having a composition, in mol %, of:
45.0 to 68.0% of SiO₂;
1.0 to 20.0% of B₂O₃;
3.0 to 20.0% of Al₂O₃;
0.1 to 10.0% of TiO₂;
0 to 9.0% of ZnO;
2.0 to 15.0% of MgO;
0 to 15.0% of CaO;
0 to 15.0% of SrO;
0 to 15.0% of BaO;
0 to 1.0% of Fe₂O₃; and
0 to 3.0% of CeO₂.

9. The glass composition according to claim 8, wherein a value of MgO+CaO+SrO+BaO, in mol %, is in a range of 5.0 to 25.0%.

10. The glass composition according to claim 8, wherein a molar ratio of (MgO+SrO+BaO)/(B₂O₃+Al₂O₃+CaO) is 0.10 to 3.00.
